(19) United States
(12) Patent Application Publication
(10) Pub. No.: US 2004/0128129 A1
(43) Pub. Date: Jul. 1, 2004

(54) Voice recognition peripheral device based wireless data transfer

(76) Inventor: William F. Sherman, Rancho Santa Margarita, CA (US)

Correspondence Address: ROBERT D. FISH; RUTAN & TUCKER, LLP, P.O. BOX 1950, 611 ANTON BLVD., 14TH FLOOR, COSTA MESA, CA, 92628-1950, US

(21) Appl. No.: 10/734,668

(22) Filed: Dec. 11, 2003

Related U.S. Application Data
(60) Provisional application No. 60/432,958, filed on Dec. 11, 2002.

(51) Int. Cl. G10L 15/00

(52) U.S. Cl. 704/235

(57) ABSTRACT

A voice recognition peripheral device has a voice processor for facilitating conversion of speech into text and a communication port for facilitating communication with a computer. The voice recognition peripheral device may cooperate with a PDA to provide speech recognition and/or text to speech conversion for a variety of different applications.

### PRIORITY CLAIM

This patent application claims the benefit of the priority date of U.S. Provisional Patent Application Serial No. 60/432,958, filed on Dec. 11, 2002 and entitled VRPD-Based Wireless Data Transfer (docket no. 100685.0004PRO3) pursuant to 35 USC 119, the entire contents of which are hereby expressly incorporated by reference.

### FIELD OF THE INVENTION

The present invention relates generally to computer systems. The present invention relates more particularly to a wireless voice recognition peripheral device which cooperates with a PDA or the like to facilitate voice input of computer commands and data.

### BACKGROUND OF THE INVENTION

Wireless data communications to and from handheld devices such as personal digital assistants (PDAs) enjoy increasing acceptance as prices for such devices decrease. Among other applications, real estate agents may employ a wireless PDA (e.g., CreSenda) to obtain up-to-date information on listings, images of properties, client email, etc., while working in the field. In another exemplary application, a telephone/PDA combination (e.g., Symbia by Nokia) allows a user to send wireless email to a computer or other recipient.

While wireless data transfer to and from PDAs is generally desirable, several difficulties still remain. For example, where the PDA is predominantly utilized to display previously stored information from a remote location, the downloadable data are often limited to the data provided by the content provider. On the other hand, where uploading information to a remote computer is desired, the information typically needs to be keyed into the PDA. Inputting information into a PDA, however, is generally cumbersome and frequently involves an attachable/detachable keyboard, a touch pad input, or a direct connection to a desktop or laptop computer from which the data is transferred to the PDA, all of which tend to impose undesirable limitations upon the user.

Other wireless communication devices, particularly digital cellular telephones, transfer relatively large quantities of data to a remote receiver. However, such devices are typically restricted to the transfer of data in a single format in which voice data or text data are merely relayed. For example, wireless phones relay acoustic information from one point to another, or relay a text message (e.g., email message) from one point to another.

It seems to have not been previously appreciated to employ a voice recognition device (which may be embodied as a peripheral device) that combines voice recognition capabilities with text processing and wireless information transfer. Therefore, there is a need to provide improved wireless communications by providing such a device.

### SUMMARY OF THE INVENTION

The present invention mitigates the above discussed deficiencies associated with the prior art. According to one aspect, the present invention comprises a voice recognition peripheral device which cooperates with an associated computer, preferably a handheld portable computer such as a PDA, to provide voice recognition, wireless communications, and other services.

The voice recognition peripheral device generally comprises a voice processor for facilitating conversion of speech into text and a communication port for facilitating communication with the associated computer. The voice processor comprises either a general purpose microprocessor or a dedicated microprocessor which is specifically configured to process speech into text. Any desired combination of general purpose microprocessor(s) and dedicated microprocessor(s) may similarly be utilized. Thus, multiple processors, optionally operating in parallel, may optionally be provided.

The communication port preferably facilitates electrical communication and mechanical attachment to a PDA. However, the communication port may alternatively facilitate electrical communication and/or mechanical attachment to any other desired type of computing device.

The communication port preferably comprises a mechanical connector, such as a parallel port, serial port, or USB port. Alternatively, the communication port comprises a wireless (non-mechanical) port such as a radio frequency, infrared, or other wireless port. Those skilled in the art will appreciate that various other types of connectors or ports are likewise suitable. Indeed, the voice recognition peripheral device may communicate with its associated computing device via any desired means. Thus, the communication port may provide mechanical connection to the PDA or alternatively may not provide such mechanical connection. Indeed, when radio frequency, infrared, or another wireless communication port is utilized, no mechanical connection is necessary and it is generally sufficient that the voice recognition peripheral device merely be in the proximity of the PDA.

The voice recognition peripheral device preferably comprises a housing. A portion of the housing is preferably generally complimentary to a PDA, so as to facilitate mating therewith. Thus, the housing may, for example, comprise a slot which receives at least a portion of a PDA. Alternatively, the voice recognition peripheral device may not comprise a housing, but rather may be embodied as a card, such as a PCI card, to facilitate electrical connection to a desktop personal computer, for example. As a further alternative, the voice recognition peripheral device may be embodied as a PCMCIA card (a PC card) to facilitate connection to a laptop computer, notebook computer, or the like.

The voice recognition peripheral device of the present invention preferably further comprises a radio transceiver for facilitating communication with a remote device. The transceiver facilitates communication of the voice recognition peripheral device/PDA (or the voice recognition peripheral device and any other desired computing device) with a remote computer, a remote network of computers, such as the Internet, a cellular telephone system, a paging system, the GPS satellite positioning system, or any other desired device or system.

Optionally, the transceiver comprises a radio transceiver which communicates via a cordless home telephone system, a cellular telephone system, an IEEE 802.11 compliant system, or any other desired communications system. Optionally, the transceiver is Bluetooth and/or WiFi compliant.

Alternatively, the transceiver may comprises an electro-optical transceiver, such as an infrared transceiver.

The processor preferably cooperates with a PDA to convert speech into text. By cooperating with the PDA to convert speech into text, advantage is taken of the processing power of the PDA, thus reducing the processing power required of the voice recognition peripheral device. However, the processor of the voice recognition peripheral device may alternatively operate as a stand-alone device to convert speech into text. Operating the processor as a standalone device may potentially free the processor of the PDA to perform other tasks.

Optionally, the voice recognition peripheral device of the present invention further comprises a voice processor for converting text into speech. The voice processor for converting text into speech may be either a general purpose microprocessor or a dedicated processor. The voice recognition peripheral device is preferably also capable of converting text, such as communications received from a remote network or device, into audible speech. As such, bi-directional speech communication between a human operator of the voice recognition peripheral device/PDA system and a remote human, computer or other device is facilitated.

Preferably the voice recognition peripheral device further comprises a microphone for receiving voice and for providing an electrical signal representative thereof. Optionally, the voice recognition peripheral device may comprise at least one analog and/or digital input port for receiving voice information from another source, such as a recording, a remote microphone or headset, or any other desired source.

Preferably, the voice recognition peripheral device further comprises a speaker for receiving an electrical signal and for providing an audio output representative thereof. Optionally, the voice recognition peripheral device may comprise at least one analog and/or digital output port for providing voice information to another device, such as a remote speaker or headset, a recording device, or any other desired device.

A memory is preferably in electrical communication with the processor so as to facilitate the conversion of speech into text. The memory optionally comprises a non-volatile memory within which a program executed by the processor is stored for facilitating speech recognition and optionally for facilitating text to speech conversion. The memory also preferably comprises a volatile working memory (RAM).

Thus, according to one aspect, the present invention comprises a voice recognition system comprising a PDA and a voice recognition peripheral device which cooperates with the PDA to facilitate the conversion of speech into text.

According to one aspect, the present invention comprises a method for processing speech, wherein the method comprises attaching a voice recognition peripheral device to a PDA, receiving speech via a microphone, converting the received speech into a digital audio signal representative thereof, processing the digital audio signal at least partially within the voice recognition peripheral device to convert the digital audio signal into text, and communicating the text to the PDA and/or a remote device or network.

Optionally, the digital audio signal is processed at least partially within the PDA to convert the digital audio signal into text. Alternatively, the digital audio signal is processed completely within the voice recognition peripheral device.

Optionally, the converted text is displayed. The converted text may be displayed directly upon the voice recognition peripheral device, upon the PDA, or upon an external viewing device in communication with the voice recognition peripheral device and/or the PDA.

Optionally, the test is encrypted. The text may be encrypted by either the voice recognition peripheral device or the PDA or by both devices in cooperation with one another.

Optionally, prior to transmitting the text from the voice recognition peripheral device, a code (such as the ASCII code) of the text is modified, a format of the text is modified, a language of the text is modified, the text itself is modified, information from the text is deleted, and/or information is added to the text.

The text may optionally be transmitted from the voice recognition peripheral device in encrypted form. Similarly, encrypted text may be received by the voice recognition device and then decrypted for use by the PDA.

The text may optionally be associated with other information. For example, the text may be placed into a desired location of a document (such as into the body of a letter), a desired field of a database, or a desired cell of a spreadsheet

Text from a remote source may optionally be input into the voice recognition peripheral device. The received text may optionally be encrypted as mentioned above, and may be decrypted by the voice recognition peripheral device, the PDA, or the cooperation of the voice recognition peripheral device with the PDA.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWING

FIG. 1 is a perspective schematic view of an exemplary voice recognition peripheral device coupled to a PDA according to the present invention.

### DETAILED DESCRIPTION

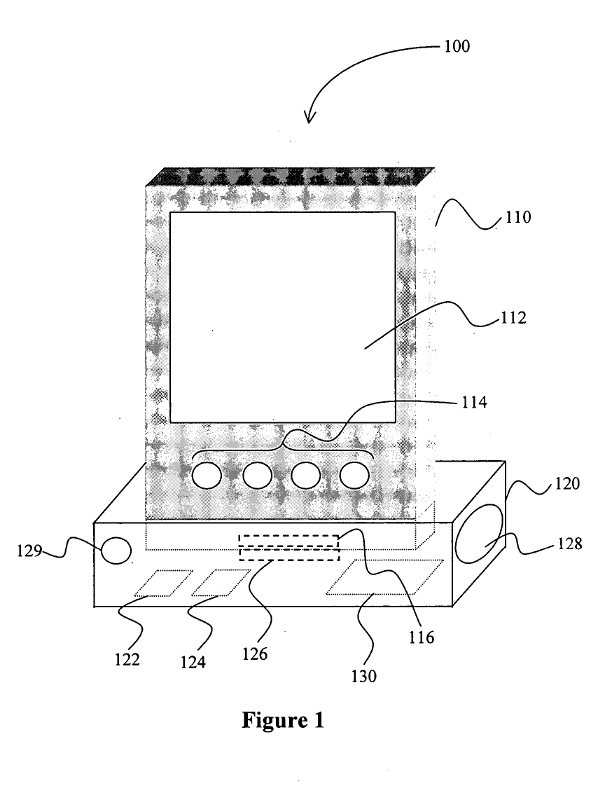

FIG. 1 shows an exemplary voice recognition peripheral device/PDA combination 100 of the present invention, in which a PDA 110 is inserted into a voice recognition peripheral device 120, so as to be in electrical communication therewith. Alternatively, the voice recognition peripheral device 120 may placed in electrical communication with the PDA 110 by some other means. For example, the voice recognition peripheral device 120 may be inserted into a slot in the PDA 110, be attached to the PDA 110 via a cable, or use a wireless means of communication with the PDA 110, such as a radio or infrared link.

Although the voice recognition peripheral device is described herein as being for use with a PDA, those skilled in the art will appreciate that the voice recognition peripheral device may similarly be used with a variety of other computing and processing devices. For example, the voice recognition peripheral device of the present invention may similarly be used with desktop computers, laptop computers, notebook computers, and wearable computers. Indeed, the voice recognition peripheral device of the present invention may additionally be used with custom processors, such as microcontrollers used in various industrial process control systems such as those associated with chemical manufacturing, pharmaceutical manufacturing, and petroleum refining. Thus, discussion herein as being for use with a PDA is by way of example only, and not by way of limitation.

The PDA 110 typically has a display portion 112 and a plurality of control buttons 114, and also typically has an electronic interface 116 on the bottom portion of the PDA. The interface 116 of the PDA is in electrical communication with the voice recognition peripheral device 120 via corresponding voice recognition peripheral device port 126. The voice recognition peripheral device port 126 is further electronically coupled to a processor 122. The processor 122 is further electronically coupled to a memory 124, microphone 129, speaker 128, and a transceiver 130.

The processor 122 may be a general purpose microprocessor, such as those commonly used in personal computers. Alternatively, the processor 122 may comprise a custom or dedicated processor which is specifically configured to process speech.

If the processor 122 comprises a general purpose microprocessor, then standard, off-the-shelf voice processing software may be utilized. Examples of such standard, off-the-shelf voice processing software include Naturally Speaking (a federally registered trademark of Softscan, Inc. of Peabody, Mass.) and Via Voice (a federally registered trademark of IBM Corp. of Armonk, N.Y.).

In a particularly preferred aspect of the inventive subject matter, the voice recognition peripheral device or voice recognition peripheral device/PDA combination is configured to translate both voice into text and text into speech. Preferred voice recognition peripheral devices or voice recognition peripheral device/PDA combinations comprise a processor that executes a program that processes text generated by the voice recognition software, as well as text received by the transceiver 130.

Particularly preferred text processing includes formatting (e.g., business letter style, memo/email style), translating (e.g., from a first to a second language, encoding, etc.), and associating with data previously stored in the voice recognition peripheral device and/or PDA. It is generally preferred that the voice recognition peripheral device functionally cooperates with the PDA (e.g., processing of the text), however, it should also be appreciated that the voice recognition peripheral device may operate as a stand-alone device.

Consequently, in an especially contemplated aspect of the inventive subject matter, a user verbally communicates information to the voice recognition peripheral device or voice recognition peripheral device/PDA combination, and the voice recognition peripheral device or voice recognition peripheral device/PDA combination translates the verbal information into text via voice recognition software. The text is subsequently transferred via the interface of the voice recognition peripheral device to the PDA, in which the text is encrypted. The encrypted text is then transferred to the transceiver in the voice recognition peripheral device via the interface and sent to the recipient using any suitable wireless transmission protocol.

Similarly, it is contemplated that the voice recognition peripheral device or voice recognition peripheral device/PDA combination may receive a wireless encrypted text message, which is first transferred to the PDA via the interface, subsequently decrypted by a software in the PDA, and transferred back to the voice recognition peripheral device that converts the decrypted text to speech.

In alternative aspects of the inventive subject matter, the processing of the text need not be limited to encryption, and alternative processing includes modifying the code of the text that is to be sent, modifying the format of the text, and in addition, removal or modification of the text that is to be sent. For example, contemplated code modifications include translation from one language into at least one other language which may be character, or sign, based (e.g., English into French, German, Japanese, or Braille). Thus, the input language may be either spoken or non-spoken, and similarly, the output language may be either spoken or non-spoken.

In another example, contemplated format modifications include formatting the text into predefined formats such as memo format, business letter, presentation format, etc. Alternatively, it is contemplated that the text may be associated with other information, which may be stored on the voice recognition peripheral device and/or PDA. For example, where a business letter is to be sent, a company logo, or electronic signature may be added.

On the other hand, where it is desirable to edit the text prior to transmission, some of the text may be deleted or modified. Likewise, it should be recognized, that where the voice recognition peripheral device or voice recognition peripheral device/PDA combination receives text, processing of the text may include modifying the code of the received text, modifying the format of the received text, and addition, removal or modification of the received text (examples supra).

It is further contemplated that the processing of the data is preferably controlled by a program which is preferably executed on a processor within the PDA, within the voice recognition peripheral device, or within a combination of both.

It should be appreciated that the data generated in the voice recognition peripheral device (i.e., text generated from voice recognition, or text received by the transceiver in the voice recognition peripheral device) may be processed in at least two output modes. The data may be output to a visual display device and/or may be converted to audible speech and then output to a speaker or the like. For example, where a user verbally communicates information to the voice recognition peripheral device/PDA combination, the information may be translated in the voice recognition peripheral device into text, and the text is subsequently displayed on the PDA screen. Based on the displayed text, the user may then further process the text (e.g., formatting, adding information, translating, etc.) and then send the processed text to a recipient. In another example, a user may receive a text information on the voice recognition peripheral device/PDA combination, which is subsequently processed (e.g., decrypted), displayed on the PDA screen, and converted into speech by the voice recognition peripheral device.

With respect to the transceiver unit, it is generally preferred that the transmission employs technology utilized in cellular telephones, however, various alternative methods of transmission are also contemplated, and include radio transmission employed in cordless home phones (e.g., 40 MHz, 900 MHz, or 1.3 GHz), opto-electronic transmission (e.g., infrared transmission), wireless LAN (WLAN) using IEEE Std 802.11 or similar and/or the emerging Bluetooth and/or WiFi standards.

Consequently, a method of voice recognition peripheral device-based wireless data transfer may comprise a process in which a voice recognition peripheral device or a voice recognition peripheral device/PDA combination is provided, wherein the voice recognition peripheral device or voice recognition peripheral device/PDA combination comprises a voice recognition/text-to-speech module, a text processing module, and a wireless transceiver module. In a further process, a user verbally communicates information to the voice recognition peripheral device or voice recognition peripheral device/PDA combination that is translated into text. In a still further process, the text is processed, the processed text is optionally displayed on the PDA, and transmitted to a recipient employing a wireless transmission protocol.

In another method, the voice recognition peripheral device or voice recognition peripheral device/PDA combination further receives text that is subsequently modified by the voice recognition peripheral device or voice recognition peripheral device/PDA combination. The modified text is then communicated to the user by converting the modified text into speech and optionally by displaying the modified text on a PDA screen.

Speech input to the voice recognition peripheral device or voice recognition peripheral device/PDA combination may be used for communicating information to a person, such as in text messaging. Such speech may also be used to control the PDA or another computer with which the voice recognition peripheral device or voice recognition peripheral device/PDA combination communicates. Such speech may also be used to control an industrial process (such as the quantity of a reagent to be added during a chemical process or the desired speed of a motor).

Similarly, speech output from the voice recognition peripheral device or voice recognition peripheral device/PDA combination may be used for communicating information from a person, such as in text messaging. Such speech may also be used to receive information from the PDA or another computer with which the voice recognition peripheral device or voice recognition peripheral device/PDA combination communicates. Such speech may also be used to receive information from an industrial process (such as the quantity of a reagent actually added during a chemical process or the actual speed of a motor).

Thus, specific embodiments and applications of voice recognition peripheral device-based wireless data transfer have been disclosed. It should be apparent, however, to those skilled in the art that many more modifications besides those already described are possible without departing from the inventive concepts herein.

I claim:

1. A voice recognition peripheral device comprising:
a voice processor for facilitating conversion of speech into text; and
a communication port for facilitating communication with a computer.

2. The voice recognition peripheral device as recited in claim 1, wherein the voice processor comprises a general purpose microprocessor.

3. The voice recognition peripheral device as recited in claim 1, wherein the voice processor comprises a dedicated microprocessor.

4. The voice recognition peripheral device as recited in claim 1, wherein the communication port facilitates mechanical attachment to a PDA.

5. The voice recognition peripheral device as recited in claim 1, wherein the communication port comprises a mechanical connector.

6. The voice recognition peripheral device as recited in claim 1, wherein the communication port comprises a wireless communication port.

7. The voice recognition peripheral device as recited in claim 1, wherein the communication port comprises a radio frequency communication port.

8. The voice recognition peripheral device as recited in claim 1, further comprising a housing, the housing having a portion thereof which is generally complimentary to a PDA, so as to facilitate mating therewith.

9. The voice recognition peripheral device as recited in claim 1, further comprising a housing, the housing having a slot formed therein so as to facilitate mechanical and electrical mating with a PDA.

10. The voice recognition peripheral device as recited in claim 1, further comprising a transceiver for facilitating communication with a remote device.

11. The voice recognition peripheral device as recited in claim 1, further comprising a radio transceiver which communicates via a cordless home telephone system.

12. The voice recognition peripheral device as recited in claim 1, further comprising a radio transceiver which communicates via a cellular telephone system.

13. The voice recognition peripheral device as recited in claim 1, further comprising a radio transceiver which communicates via an IEEE 802.11 compliant system.

14. The voice recognition peripheral device as recited in claim 1, further comprising a radio transceiver which communicates via a Bluetooth compliant system.

15. The voice recognition peripheral device as recited in claim 1, further comprising a radio transceiver which communicates via a WiFi compliant system.

16. The voice recognition peripheral device as recited in claim 1, further comprising an infrared transceiver.

17. The voice recognition peripheral device as recited in claim 1, wherein the processor cooperates with a PDA to convert speech into text.

18. The voice recognition peripheral device as recited in claim 1, wherein the processor operates as a stand-alone device to convert speech into text.

19. The voice recognition peripheral device as recited in claim 1, further comprising a voice processor for converting text into speech.

20. The voice recognition peripheral device as recited in claim 1, further comprising a microphone for receiving voice and for providing an electrical signal representative thereof.

21. The voice recognition peripheral device as recited in claim 1, further comprising a speaker for receiving an electrical signal and for providing an audio output representative thereof.

22. The voice recognition peripheral device as recited in claim 1, further comprising a memory in electrical communication with the processor for facilitating the conversion of speech into text.

23. A voice recognition system comprising a PDA and a voice recognition peripheral device which cooperates with the PDA to facilitate conversion of speech into text.

24. A method for processing speech, the method comprising:
attaching a voice recognition peripheral device to a PDA;
receiving speech via a microphone;
converting the received speech into a digital audio signal representative thereof;
processing the digital audio signal at least partially within the voice recognition peripheral device to convert the digital audio signal into text; and
communicating the text to the PDA.

25. The method as recited in claim 24, further comprising processing the digital audio signal at least partially within the PDA to convert the digital audio signal into text.

26. The method as recited in claim 24, further comprising displaying the converted text.

27. The method as recited in claim 24, further comprising encrypting the text.

28. The method as recited in claim 24, further comprising encrypting the text in the PDA.

29. The method as recited in claim 24, further comprising transmitting the text from the voice recognition peripheral device to a remote device.

30. The method as recited in claim 24, further comprising performing at least one of the following and then transmitting the text from the voice recognition peripheral device:
modifying a code of the text;
modifying a format of the text;
modifying a language of the text;
modifying the text;
deleting information from the text; and
adding information to the text.

31. The method as recited in claim 24, further comprising transmitting the text from the voice recognition peripheral device in encrypted form.

32. The method as recited in claim 24, further comprising associating the text with other information.

33. The method as recited in claim 24, further comprising receiving text into the voice recognition peripheral device.

34. The method as recited in claim 24, further comprising receiving text into the voice recognition peripheral device in encrypted form.
